(19) United States
(12) Patent Application Publication
(10) Pub. No.: US 2012/0153239 A1
(43) Pub. Date: Jun. 21, 2012

(54) Formation of High Electrical Conductivity Polymer Composites with Multiple Fillers

(75) Inventors: Bukkinakere Kapanipathaiya Chandrasekhar, Bangalore (IN); Manjunatha Hosahalli Ramachandraiah, Bangalore Rural District (IN); Padma Priya Sudarshana, Mysore (IN); Sreejith Valiavalappil, Kannur (IN)

(73) Assignee: LAIRD TECHNOLOGIES, INC., Earth City, MO (US)

(21) Appl. No.: 13/398,300

(22) Filed: Feb. 16, 2012

Related U.S. Application Data
(63) Continuation of application No. PCT/US2010/043844, filed on Jul. 30, 2010.

(30) Foreign Application Priority Data
Aug. 17, 2009 (IN) 1889/MUM/2009

(51) Int. Cl. H01B 1/22; B29C 45/00; B29C 47/00; B29C 43/02

(52) U.S. Cl. 252/514; 252/512; 264/104

(57) ABSTRACT

Electrically conductive compositions and composites, and methods of making the same are disclosed herein. An exemplary electrically conductive composite includes a polymer and a filler comprising a porous particle at least partially coated with metal. Additional fillers may be added, including metal particles such as acicular copper. Also disclosed are articles including the polymers and fillers and methods for their manufacture, where such articles may include an interconnect, circuit board, semiconductor, radio frequency identification tag, printed circuit, flexible circuit, tape, film, adhesive, gasket, sealant, ink, or paste.

### CROSS-REFERENCE TO RELATED APPLICATIONS

This application is a continuation of PCT Application No. PCT/US2010/043844 filed Sep. 15, 2009, which, in turn claims and priority of India Patent Application No. 1889/MUM/2009 filed Aug. 17, 2009. The entire disclosures of the above applications are incorporated herein by reference.

### FIELD

The present disclosure relates to electrically conductive composites, including composites useful as electromagnetic interference (EMI) shielding.

### BACKGROUND

This section provides background information related to the present disclosure which is not necessarily prior art.

Enhancement of electrical and thermal conductivities of composites requires suitable fillers with high filler loadings. Typical fillers used for making conductive articles include metals, metallic salts (e.g., aluminum salts, etc.), ceramics (e.g., calcium salts, aluminum nitride, boron nitride, calcium phosphates, hydroxyapatite, calcium carbonates, calcium sulfates, combinations thereof, etc.) and carbon (e.g., carbon fibers, graphite, carbon black in various forms ranging from nano to micrometer size range, etc.). Objectives in the field of electrically conductive and thermally conductive article manufacture include obtaining desired property values with minimum amounts of fillers.

Aspects of electrically conductive and thermally conductive composites include loading of filler material, filler uniformity in the composite, and conductivity of the resultant composite. High electrical and thermal conductive values can require higher amounts of filler loading. Fillers can have different densities, which can result in segregation of filler materials in the composite, making uniform distribution of filler difficult to achieve. This may be problematic as an inhomogeneous distribution of fillers may lead to poor and inconsistent properties. In addition, choice and availability of processing methods, such as injection molding, can be tied to the amount of filler loading as the filler amount affects the viscosity, where some processing methods are amendable only to particular viscosity ranges and particular filler amounts. Conductivity of the composite is an important aspect regarding the end-use of the material; for example, enhanced electrical conductivity can enhance EMI shielding.

As recognized by the inventors hereof, improved filler loading, distribution, and electrical conductivity of polymer composites would facilitate superior EMI shielding. Further, the inventors have also recognized that composites having high electrical conductivities would also improve other material applications, such as electrically conducting elastomers (ECE), coatings, gaskets, tapes, sealants and inks used in various electronic devices.

### SUMMARY

This section provides a general summary of the disclosure, and is not a comprehensive disclosure of its full scope or all of its features.

In some embodiments, an electrically conductive composite comprises a polymer and a filler comprising porous particles at least partially coated with metal. By way of example, the metal coating may include copper, silver, or a combination of copper and silver, among other metals. By way of further example, the porous particles may include various porous mineral particles. In some cases, the filler also comprises metal particles, where the metal particles may have an aspect ratio from about 2:1 to 10:1 with respect to their longest versus shortest axis. For example, the metal particles may comprise acicular copper particles, where the metal particles may also comprise a coating of a different metal, such as silver. Electrically conductive composites disclosed herein may have the filler substantially dispersed throughout the polymer and the polymer may include one or more polymeric fibers. The exemplary electrically conductive composites can provide conductivities ranging from about 1 S/cm to about 1500 S/cm.

In some embodiments, methods of making an electrically conductive composite include mixing a polymer and a filler to substantially disperse the filler in the polymer, wherein the filler comprises porous particles at least partially coated with metal. Methods may further comprise extruding the polymer and the filler to form an article comprising the electrically conductive composite, including injection molding or compression molding the polymer and filler to form an article comprising the electrically conductive composite.

In some embodiments, articles are manufactured according to the present methods. For example, articles made of the present electrically conductive composites include interconnects, circuit boards, semiconductors, radio frequency identification tags, printed circuits, and flexible circuits.

In some embodiments, the present electrically conductive composites are used in methods of shielding an electronic device from electromagnetic interference. These methods include covering at least a portion of the electronic device with an electrically conductive composite. For example, the electromagnetic interference shielding may be greater than about 50 decibels in some embodiments and may be greater than about 60 decibels in other embodiments.

The exemplary embodiment of compositions and methods may be used to provide electrically and/or thermally conductive articles, such as tapes, polymeric films, polymer composites, highly thermally conductive injection moldable thermoplastic composites, highly electrically conductive injection moldable thermoplastic composites, conductive adhesives, etc. The articles may include metal coated porous particles along with other high aspect ratio fillers.

Further areas of applicability will become apparent from the description provided herein. The description and specific examples in this summary are intended for purposes of illustration only and are not intended to limit the scope of the present technology.

### DRAWINGS

The drawing described herein is for illustrative purposes only of selected embodiments and not all possible implementations, and is not intended to limit the scope of the present disclosure.

FIG. 1 graphically depicts the relationship between voltage and current for an embodiment of an electrically conductive composite in accordance with embodiments of the present technology.

### DETAILED DESCRIPTION

The following description of technology is merely exemplary in nature of the subject matter, manufacture, and use of one or more inventions, and is not intended to limit the scope, application, or uses of any specific invention claimed in this application or in such other applications as may be filed claiming priority to this application, or patents issuing therefrom. The following definitions and non-limiting guidelines must be considered in reviewing the description of the technology set forth herein.

The headings (such as “Background” and “Summary”) and sub-headings used herein are intended only for general organization of topics within the present technology, and are not intended to limit the disclosure of the present technology or any aspect thereof. In particular, subject matter disclosed in the “Background” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The citation of references herein does not constitute an admission that those references are prior art or have any relevance to the patentability of the technology disclosed herein. Any discussion of the content of references cited in the Background is intended merely to provide a general summary of assertions made by the authors of the references, and does not constitute an admission as to the accuracy of the content of such references. All references cited in the “Description” section of this specification are hereby incorporated by reference in their entirety.

The description and specific examples, while indicating embodiments of the technology, are intended for purposes of illustration only and are not intended to limit the scope of the technology. Moreover, recitation of multiple embodiments having stated features is not intended to exclude other embodiments having additional features, or other embodiments incorporating different combinations of the stated features. Specific examples are provided for illustrative purposes of how to make and use the compositions and methods of this technology and, unless explicitly stated otherwise, are not intended to be a representation that given embodiments of this technology have, or have not, been made or tested.

As used herein, the words “preferred” and “preferably” refer to embodiments of the technology that afford certain benefits, under certain circumstances. But other embodiments may also be preferred, under the same or other circumstances. Furthermore, the recitation of one or more preferred embodiments does not imply that other embodiments are not useful, and is not intended to exclude other embodiments from the scope of the technology.

As referred to herein, all compositional percentages are by weight of the total composition, unless otherwise specified. As used herein, the word “comprise”, “include,” and variants thereof are intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present technology that do not contain those elements or features.

Disclosure of values and ranges of values for specific parameters (such as temperatures, molecular weights, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting ingredients, components or process steps, Applicants specifically envision embodiments consisting of, or consisting essentially of, such ingredients, components or processes excluding additional ingredients, components or processes (for consisting of) and excluding additional ingredients, components or processes affecting the novel properties of the embodiment (for consisting essentially of), even though such additional ingredients, components or processes are not explicitly recited in this application. For example, recitation of a composition or process reciting elements A, B, and C specifically envisions embodiments consisting of, and consisting essentially of, A, B, and C, excluding an element D that may be recited in the art, even though element D is not explicitly described as being excluded herein.

“A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. In addition, disclosure of ranges includes disclosure of all distinct values and further divided ranges within the entire range.

The present technology relates to electrically conductive composites, methods of making electrically conductive composites, articles formed by the present methods and/or articles having at least a portion that includes one or more of the present composites. An electrically conductive composite according to the present technology includes one or more polymers and at least one filler, such as metals and/or metal-coated porous minerals. One or more of the fillers provides an electrically conductive network within the polymer matrix in order to provide a pathway for electrical conductivity through the composite. The present composites provide excellent electrical conductivity, with values ranging from about 1 siemens per centimeter (S/cm) to greater than about 1000 S/cm, which is higher than many, if not most, electrically conductive composites that include specialized fillers.

The present electrically conductive composites may be formed using manufacturing processes such as extrusion, injection molding, and compression molding. For example, injection molding allows the present composites to be formed into many different shapes and sizes using available equipment and systems. These fabrication processes may also be performed in a continuous fashion (e.g., using a twin-screw extruder) providing benefits with respect to production time and cost-effectiveness.

The present technology uses specialized fillers for obtaining high electrical conductivity. These fillers facilitate a uniform and high level of filler loading in the polymer matrix. For example, the present fillers may include minerals (e.g., perlite, etc.) coated with single or multiple layers of metals, silver-coated copper particles, silver-coated star-shaped copper or acicular copper particles, combinations of these fillers, including combinations with other fillers. By way of example, embodiments may include one or more of the materials, particles, or fillers disclosed in any one or more India Patent Application Number 1163/MUMNP/2009 filed May 9, 2009; India Patent Application Number 1164/MUMNP/2009 filed May 4, 2009; and/or India Patent Application Number 2501/HE/2008 filed Oct. 14, 2008. The entire disclosures of each of the above three India patent applications are incorporated herein by reference.

Electrical conductivity of composites including one or more conductive fillers dispersed in a polymer matrix depends on filler loading, according to percolation theory, as the polymer alone is typically insulating in nature. At a low filler concentration, the fillers may be present as small clusters or individual particles, and since the average distance between the filler particles may exceed their size, the conductivity of the polymer composite may be close to that of the pure polymer matrix. When a sufficient amount of filler is loaded, a percolation path of connected filler particles forms and allows charge transport through the composite sample. At this critical concentration, known as the percolation threshold, the conductivity abruptly and rapidly increases. As such, the electrical conductivity of the composite can be heavily dependent on the characteristics of the fillers and the amount of fillers. Higher amounts of fillers typically equate with higher electrical conductivity. However, there are limits to the practical amount of filler, as high loading may subsequently lead to processing difficulties due in part to high viscosity.

In addition, the value of the percolation threshold may be influenced by geometrical considerations, in particular, the aspect ratio (i.e., ratio of length-to-diameter) of the filler particles. Considering a filler system having a particular filler orientation, the percolation threshold can decrease with an increase in aspect ratio of the filler; i.e., the percolation threshold and aspect ratio may have an inverse relationship. Similarly, filler with a higher aspect ratio may provide a lower percolation threshold than a substantially similar amount of filler with a lower aspect ratio. With respect to the present electrically conductive composites, useful fillers may possess excellent conductivity combined with high aspect ratios.

The present electrically conductive composites may also be made by loading fillers into a polymer matrix in high quantities without compromising on processability. This can be accomplished, for example, by injection molding the composition with high loading of fillers with ease and obtaining very high electrical conductivity of several hundred S/cm, and even more than 1000 S/cm in some cases. In some cases, the total amount of fillers used may be up to 85% by volume of the composite in order to obtain the highest conductivity. The composites may employ one or more polymers, including thermosets (e.g., for conducting pastes, tapes, gaskets), elastomers, as well as injection molded parts of any size or shape using thermoplastics and/or thermoplastic elastomers.

Embodiments of the present electrically conductive composites include a filler, and may include multiple fillers, in addition to one or more polymers. Fillers include metals with high aspect ratios, such as acicular copper, and include such metals further coated with a different metal. Fillers also include metal coated porous minerals, such as metal coated perlite. Porous mineral fillers may be coated with more than one type of metal and/or layers of metals. The present composites further include combinations of the various fillers and various polymers as provided herein.

The present fillers may be metal coated fillers, such as metal coated porous materials and/or metal coated minerals. Such porous filler particles can have a plurality of pores with a plurality of metal particles deposited or coated onto and inside the filler particles and pores, including the interior surfaces of the pores. In some cases, high loading of fillers in a composite can be difficult to achieve as increases in viscosity may limit material processing methods; e.g., higher viscosities may preclude injection molding methods. Differences in densities may also lead to segregation of particles resulting in heterogeneity within the composite. The present compositions and methods can overcome these problems by providing highly conductive composites having metallic coatings and/or metallic particles (e.g., copper, silver, etc.) coated or deposited on a highly porous material. For example, a filler may comprise a metal coated mineral (e.g., perlite, etc.).

Metal particles and multi-layered metal particles may also serve as fillers. For example, fillers include silver-coated copper particles, silver-coated star-shaped copper particles, and acicular copper particles (i.e., needle-like particles having a high aspect ratio). Metal particles also include metal particles of Groups 8-12 (IUPAC) or Groups VIIIB, IB and IIB (CAS) of the periodic table. Such metals include gold, silver, platinum, copper, iron, palladium, cobalt, palladium, nickel, aluminum, zinc, and alloys thereof. The metals may be provided as metal salts and may be deposited to form particles using metal salt solutions. Metal salt solutions may include metal-containing cations, such as Cu⁺, Cu²⁺, [Cu(NH₃)₄]2⁺, Ni²⁺, Pd²⁺, Pt²⁺, Au⁺, Au³⁺, Zn²⁺, Ag⁺, Al³⁺, Cd²⁺, Fe²⁺, Fe³⁺, and combinations thereof. The metallic salt solution may include the aforementioned metal cation or a combination of metal cations with anionic species that are part of simple anions, oxoanions, and organic acid anions. The metal cations can be in the form of aqueous or non-aqueous solutions. For example, the anion species which forms the metallic salt may include: Cl⁻, OH⁻, NO₃⁻, NO₂⁻, PO₄³⁻, PO₃³⁻, HPO₄²⁻, H₂PO₄⁻, MnO₄⁻, SO₄²⁻, SO₃²⁻, CO₃²⁻, CrO₄²⁻, HCO₂⁻, C₂H₃O₂⁻, C₂O₄²⁻, and combinations thereof. In some cases, the anion is nitrate, acetate, and/or phosphate.

Fillers also include porous filler particles, for example, siliceous porous particles and/or non-siliceous porous particles. Non-siliceous porous filler particles can include a ceramic, including calcium phosphates, hydroxyapatite, calcium carbonates, calcium sulfates, combinations thereof, and porous metal particles. The porous filler particle can be a porous siliceous particle. Porous filler particles are advantageous in that they offer metal contact surfaces on the surface of the particle and within the pores of the particle body. Increased surface area for coating with metal particles affords higher metal particle loadings and increased uniformity of distribution of the metal particles in the conductive polymer matrix material.

Porous filler particles, for example, may include particles derived from siliceous and non-siliceous minerals having a final porosity greater than 30 percent, greater than 40 percent, greater than 50 percent, greater than 60 percent, greater than 70 percent, greater than 80 percent, greater than 85 percent, greater than 87 percent, greater than 90 percent, greater than 95 percent, or greater than 99 percent. The porous filler particles may include particles derived from siliceous and non-siliceous minerals having a final porosity from about 40 percent to about 99 percent, or from about 45 percent to about 99 percent, or from about 50 percent to about 99 percent, or from about 55 percent to about 99 percent, or from about 60 percent to about 99 percent, or from about 65 percent to about 99 percent, or from about 70 percent to about 99 percent, or from about 75 percent to about 99 percent, or from about 80 percent to about 99 percent, or from about 85 percent to about 99 percent. Preferably, the porosity range of the porous filler particles is from about 80 percent to about 99 percent.

Siliceous filler particles include silica containing particles having an elemental composition comprising from about 5 percent to about 90 percent by weight of silicon, from about 0.01 to about 25 percent by weight of aluminum, from about 0.001 to about 10 percent by weight of potassium, from about 0.001 to about 15 percent by weight of sodium, from about 0.001 to about 10 percent by weight of iron, from about 0.001 to about 5 percent by weight of calcium, from about 0.001 to about 5 percent by weight hydrogen, from about 0.001 to about 5 percent by weight of magnesium. Such compositions typically further comprise trace elements, and the balance of the compositions may be oxygen. The siliceous filler particle can include several known siliceous particles having the various porosities described above. Illustrative examples include perlite, vermiculite, pumice, montmorillonite, wollastonite, and zeolites. In some cases, siliceous filler particles may include a mixture of these various siliceous filler particles.

Perlite includes expanded perlite derived from perlite ore, which belongs to the class of natural glasses, and is commonly referred to as volcanic glass, being formed by the rapid cooling of siliceous magma and lava. Perlite ore is a hydrated natural glass containing typically about 72 to 75 percent SiO₂, about 12 to 14 percent Al₂O₃, about 0.5 to 2 percent Fe₂O₃, about 3 to 5 percent Na₂O, about 4 to 5 percent K₂O, about 0.4 to 1.5 percent CaO (by weight) and small concentrations of MgO, TiO₂ and other metallic constituents. Perlite ore may be distinguished from other natural glasses by a higher content (about 2 to 10 percent by weight) of chemically bonded water, the presence of a vitreous, pearly luster, and characteristic concentric or arcuate onion skin-like (perlitic) fractures.

Vermiculite, (MgFe,Al)₃(Al,Si)₄O₁₀(OH)₂.4H₂O, is formed by hydration of certain basaltic minerals. Vermiculite is a member of the phyllosilicate or sheet silicate group of minerals. The basic structure of the mineral is identical to the micas and to talc: a 2:1 silicate sheet composed of two flat layers of silica and alumina tetrahedra (the tetrahedral layers), which are joined together in a layer composed of apical oxygen atoms, and magnesium, iron, and hydroxyl molecules (the octahedral layer). Between the 2:1 sheets lies the ion exchangeable layer. This layer will change in thickness depending on the interlayer cation present and the arrangement of waters of hydration associated with it.

Pumice is a type of extrusive volcanic rock, produced when lava with a very high content of water and gases (together these are called volatiles) is extruded in a volcano. As the gas bubbles escape from the lava, it becomes frothy. When this lava cools and hardens, the result is a very light rock material filled with tiny bubbles of gas. The gas dissipates leaving a highly porous glass (pumice has an average porosity of 90 percent) that can be crushed to smaller particles still retaining micropores throughout the particle.

Montmorillonite, (Na;Ca)_{0.3}(Al;Mg)₂Si₄O₁₀(OH)₂.nH₂O, is a member of the clay mineral group. It typically forms microscopic or at least very small platy micaceous crystals. The water content is variable, and in fact when water is absorbed by the crystals they tend to swell to several times their original volume. Montmorillonite is a useful mineral for several purposes and is the main constituent of a volcanic ash called bentonite.

Wollastonite is a calcium inosilicate mineral (CaSiO₃) that may contain small amounts of iron, magnesium, with manganese substituting for calcium. Two main constituents forming wollastonite include CaO and SiO₂. In pure CaSiO₃, each component forms about half of the mineral by weight percentage. For example, CaO may have a weight percentage of about 48.3% and the SiO₂ may have a weight percentage of about 51.7%. In some cases, small amounts of iron, and manganese, and lesser amounts of magnesium, may substitute for calcium.

Zeolites are microporous crystalline solids with well-defined structures. A defining feature of zeolites is that their frameworks are made up of 4-connected networks of atoms. Zeolites can also be classified as aluminosilicate minerals and have a microporous structure (pores smaller than about 100 nm). Zeolites are highly porous minerals due to the water absorbed inside the zeolite's pores being driven off by heating. Approximately 175 known zeolite frameworks have been identified, and over 40 naturally occurring zeolite frameworks are known in the mineral arts. Zeolites have a porous structure that can accommodate a wide variety of cations, such as Na⁺, K⁺, Ca²⁺, Mg²⁺, and others. These positive ions or cations are rather loosely held and can readily be exchanged for others in a contact solution. Some of the more common mineral zeolites are analcime, chabazite, heulandite, natrolite, phillipsite, and stilbite. An exemplary mineral formula for one of the zeolite members is: Na₂Al₂Si₃O₁₀-2H₂O, the formula for natrolite.

Porous filler particles can be manufactured from excavated ore and are commercially available in a wide array of particle sizes. The present fillers can utilize a wide size range of particles, for example, from about 0.001 millimeter to about 5 millimeters. As used herein, the diameter of porous filler particles can be referenced as d₅₀, wherein the d₅₀ value represents particle size distribution as a median cumulative percent particle size. In other words, half the particles have an average diameter value less than the d₅₀ value and half the particles have an average diameter value greater than the d₅₀ particle size. This value is therefore a measure of the fineness of the particles. In various embodiments, the value of d₅₀ of porous filler particles may be 5 millimeters or less, 4 millimeters or less, 3 millimeters or less, 2 millimeters or less, 1 millimeters or less, 0.5 millimeters or less, 0.1 millimeters or less, 80 micrometers or less, 60 micrometers or less, 40 micrometers or less, 30 micrometers or less, 25 micrometers or less, 20 micrometers or less, 15 micrometers or less, 10 micrometers or less, 8 micrometers or less, 6 micrometers or less, or 3 micrometers or less.

The value of d₅₀ may be as low as 1 micrometer, or even as low as 0.5 micrometers. For example, the value of d₅₀ of expanded perlite can be from about 1 μm to about 5.0 millimeter, for example, from about 10 micrometers to about 2 millimeter, from about 50 micrometers to about 1000 micrometers, or from about 100 micrometers to about 500 micrometers.

In some embodiments, particle size values pertaining to the porous filler particles can be specified as equivalent spherical diameters, which may be determined by laser light particle size analysis using a Leeds and Northrup Microtrac X100 (LNM X100) available from Leeds and Northrup, North Wales, Pa., U.S. Similar instruments are also available from Horiba, Japan (model LA 950V2). In this technique, the size of porous filler particles in powders, suspensions, and emulsions may be measured using the diffraction of a laser beam, based on application of either Fraunhofer or Mie theory. In various embodiments, Mie theory is applied. The term “mean particle size” or d₅₀ used herein is the value, determined in this way, of the particle diameter at which there are 50 percent by mass of the particles which have a diameter less than the d₅₀ value. In various embodiments, the preferred sample formulation for measurement of particle sizes is a suspension in a liquid. The LNM X100 instrument normally provides particle size data to two decimal places, to be rounded up or down when determining whether the particle size of an embodiment is satisfactory or meets certain specifications, or by other methods which give essentially the same result.

The filler may have an aspect ratio ranging from about 1:1 to about 1:50, about 1:2 to about 1:35, or about 1:5 to about 1:20. Higher aspect ratios provide needle-like particles; e.g., acicular copper particles. Aspect ratios can be calculated by the Sphericity Model from experimentally determined (using electron microscopy) surface area data as described in U.S. Pat. No. 5,846,309 to Freeman et al. Process conditions for preparing expanded perlite are disclosed in U.S. Pat. No. 2,455,666 to J. L. Fournier; U.S. Pat. No. 2,501,699 to G. Stecker; U.S. Pat. No. 2,572,483 to E. O. Howle; U.S. Pat. No. 2,621,160 to W. E. Johnson et al.; U.S. Pat. No. 3,097,832 to J. B. Murdock et al.; and U.S. Pat. No. 4,525,388 to Rehder et al.

Generally, expanded perlite, used as filler or in making a metal-coated filler, can be prepared by methods which include crushing, grinding, milling, screening, and thermal expansion. For example, perlite ore may be crushed, ground, and separated to a predetermined particle size range. The separate material can then be heated in air, typically at a temperature of from about 870 degrees Celsius to about 1100 degrees Celsius in an expansion furnace. The expanded perlite can be prepared using conventional crushing, grinding, and milling techniques, and can be separated to meet particle size requirements using separating techniques available in the art. In some embodiments, the bulk density of the porous filler particles can range from about 10 kilograms per meter cubed (kg/m³) to about 300 kg/m³, or from about 10 kg/m³ to about 250 kg/m³, or from about 10 kg/m³ to about 200 kg/m³, or from about 10 kg/m³ to about 150 kg/m³, or from about 10 kg/m³ to about 100 kg/m³.

The following is an example of a method for producing silver coated filler. In this method, an amount of expanded perlite Norlite® N50, (NorCal, Richmond Calif., United States, density 4.5-6.6 pounds per cubic foot (lbs/ft³) (72-106 kilograms per cubic meter (kg/m³)), mesh size 24-100) is added to refluxing ethylene glycol (1,2 ethanediol; CAS Number 107-21-1, Molecular Weight 62.07 Daltons Spectrophotometric Grade >99 percent purity, Sigma-Aldrich, Saint Louis, Mo., United States) preheated to about 180 degrees Celsius to make a 100 milliliter support mixture. A measured amount of silver acetate (acetic acid silver salt; CAS Number 563-63-3, Molecular Weight 166.91 99.99 trace metal basis, Sigma-Aldrich, Saint Louis, Mo., United States) 0.17 grams is mixed with 100 milliliter ultrapure reverse osmosis water (Millipore Pure water) to make a silver salt solution. The silver salt solution and the 100 milliliter support mixture are added together forming a reaction mixture and sonicated. The reaction mixture is sonicated using a laboratory ultrasonicator (e.g., Branson Ultrasonics, Sonifier® Model S-450A, Danbury, Conn., United States) for complete (or at least substantially complete) wetting and removal of air from within the pores of perlite filler particles. The reaction mixture is heated to a temperature within range of about 50 degrees Celsius to about 180 degrees Celsius under relatively constant stirring and kept within the temperature range for 1 hour to help ensure complete reduction of the silver acetate to silver metal coated on the surface and within the pores of the perlite filler particles. The silver coated perlite filler particles is then removed from the container, quenched in cold water and filtered in a Büchner funnel twice using water and then ethanol.

The following is an example of a method for producing copper coated filler. In this example, the method steps for preparing a copper coated perlite particle include weighing suitable quantities of the raw materials and then mixing the materials in a glass container and stirring at temperatures of around 180 degrees Celsius. The perlite is mixed with ethylene glycol. A metallic salt, such as an acetate (for example, silver acetate or copper acetate), is added to the ethylene glycol-perlite mixture. The perlite particles are agitated using ultrasonic agitation for complete (or at least substantially complete) wetting (and removal of air from within the pores of perlite). The ultrasonicated perlite and metal salt/ethylene glycol mixture is heated to a temperature within the range of about 160 degrees Celsius to about 180 degrees Celsius under relatively constant stirring. The metal coated particle filler material produced is then filtered and the metal coated perlite particles are dried. The copper coated metal particles can be subsequently coated with silver particles by repeating the steps above, except silver acetate salt is used to coat copper coated perlite particles.

The electrically conductive composite includes one or more polymers where the polymer may comprise any suitable polymer capable of forming a composite with the electrically conductive filler particles, including various thermoplastic and/or thermosetting polymers. The polymer may be a thermoplastic polymer, such as polyphenylene sulfide (PPS), a polyamide (e.g., nylon), or a polycarbonate; or, the polymer may be a thermoset polymer, such as various melamine and epoxy resins, and polyimides. Other polymers include polycarbonates, polystyrenes, and epoxies. The polymer may be prepared and polymerized from respective monomers or the polymer may be obtained from commercially available sources.

For example, the polymer may include resins and binders forming (or formed from) curable and non-curable organic resins, such as acrylic resin, polyester resin, alkyd resin, urethane resin, silicone resin, fluororesin, epoxy resin, polycarbonate resin, polyvinyl chloride resin, polyvinyl alcohol resin, and radical polymerizable oligomers and highly and moderately polar monomers and copolymers thereof. Other polymer components include curing agents, also known as crosslinkers, can include radical polymerization initiator(s).

Examples of highly polar monomers include acrylic acid, itaconic acid, hydroxyalkyl acrylates, cyanoalkyl acrylates, acrylamides or substituted acrylamides. Examples of the moderately polar monomer include N-vinyl pyrrolidone, N-vinyl caprolactam, acrylonitrile, vinyl chloride, or diallyl phthalate.

Polymers including curable resins or binders can include one or more acrylate resins, epoxy resins, polydimethyl siloxane resins, other organo-functionalized polysiloxane resins that can form cross-linking networks via free radical polymerization, atom transfer radical polymerization, nitroxide mediated radical polymerization, reversible addition-fragmentation transfer polymerization, ring-opening polymerization, ring-opening metathesis polymerization, anionic polymerization, cationic polymerization, or any other method known to those skilled in the art, and mixtures thereof. Suitable curable binders can include silicone resins, for example, addition curable and condensation curable matrices as described in “Chemistry and Technology of Silicone,” Noll, W.; Academic Press 1968.

The curing process can be performed by any process known to those skilled in the art. For example, in some embodiments, the polymer composition may be curable or cured via electromagnetic radiation (e.g., UV light) and/or by thermal radiation. Depending on the composition, curing can also be accomplished by microwave cure, electron-beam cure, free radical cure initiated with free radical initiators and combinations thereof. Typical free radical initiators can include, for example, organic peroxides (e.g., benzoyl peroxide, etc.), inorganic peroxides (e.g., hydrogen peroxide, etc.), organic or inorganic azo compounds (e.g., 2-2′-azo-bis-isobutyrylnitrile), nitroxides (e.g., TEMPO, etc.) or combinations thereof.

In some embodiments, the polymer of the electrically conductive composite is cured with the filler material(s). For example, the filler material and the polymer components may be admixed and the polymer cured, forming a polymer matrix with embedded filler dispersed throughout. In some cases, the polymer comprises cured or partially cured beads, granules, or powder that is then mixed with the filler and may be optionally further cured.

Thermal curing of the polymer may occur at a temperature in a range from about 20 degrees Celsius to about 350 degrees Celsius, more typically in a range of about 50 degrees Celsius to about 320 degrees Celsius. In some embodiments, the binder(s) in the polymer are chosen such that the curing temperature is about 10 degrees Celsius to about 200 degrees Celsius. Curing typically occurs at a pressure in a range from about 1 atmosphere and about 5000 pounds per square inch, more typically in a range from about 1 atmosphere and about 100 pounds per square inch. In addition, curing may typically occur over a time period in a range of from about 30 seconds to about 5 hours, and more typically in a range from about 90 seconds to about 120 minutes. Optionally, the cured conductive material, paste, or coating can be post-cured at a temperature in a range from about 100 degrees Celsius to about 150 degrees Celsius over a period of from about 0.5 hour to about 4 hours, preferably from about 1 hour to about 2 hours.

In some embodiments, the polymer may comprise one or more polyarylene sulfides. Suitable examples are described, by way of example, in Saechtling, Kunststoff-Taschenbuch [Plastics handbook], Hanser-Verlag, 27th-edition, on pages 495-498, and this citation is incorporated herein by way of reference. It can be advantageous to use thermoplastic polyarylene sulfides, such as polyphenylene sulfide (PPS). Polyarylene sulfides may be prepared using dihalogenated aromatic compounds. Examples of dihalogenated aromatic compounds include p-dichlorobenzene, m-dichlorobenzene, 2,5-dichlorotoluene, p-dibromobenzene, 1,4-dichloronaphthalene, 1-methoxy-2,5-dichlorobenzene, 4,4′-dichlorobiphenyl, 3,5-dichlorobenzoic acid, 4,4′-dichlorodiphenyl ether, 4,4′-dichlorodiphenyl sulfone, 4,4′-dichlorodiphenyl sulfoxide, and 4,4′-dichlorodiphenyl ketone. It is also possible to use small amounts of other halogenated compounds, such as trihalogenated aromatics, in order to exert a specific effect on the properties of the polymer.

Polyphenylene sulfide (PPS) is a semicrystalline polymer with the general formula:

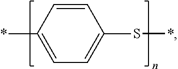

where n>1, and the average molecular weight (M_{W}) of the polymer is above about 200 g/mol.

In some embodiments, the polymer may comprise one or more liquid-crystalline polymers (LCPs). These include LCPs which are capable of thermoplastic processing. Suitable materials are described, by way of example, in Saechtling, Kunststoff-Taschenbuch, Hanser-Verlag, 27th edition, on pages 517-521, and this citation is incorporated herein by way of reference. Particular examples which may be used include polyterephthalates, polyisophthalates, PET-LCP, PBT-LCP, poly(m-phenyleneisophthalamide), PMPI-LCP, poly(p-phenylenephthalimide), PPTA-LCP, polyarylates, PAR-LCP, polyester carbonates, PEC-LCP, polyazomethines, polythioesters, polyesteramides, polyesterimides. Also included are p-hydroxybenzoic-acid-based liquid-crystalline polymers, such as copolyesters or copolyesteramides. Liquid-crystalline polymers further include polyesters which are fully aromatic and form anisotropic melts and which have average molar masses (M_{W}=weight−average) of from about 2,000 to about 200,000 g/mol, including from about 3,500 to about 50,000 g/mol, and from about 4,000 to about 30,000 g/mol.

A suitable group of liquid-crystalline polymers is described in U.S. Pat. No. 4,161,470. These include naphthoyl copolyesters with repeat structural units of the formulae I and II:

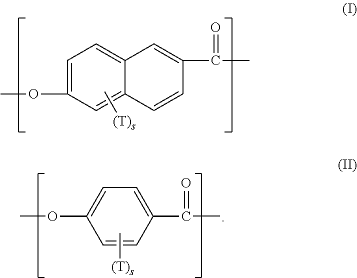

where the T selected is an alkyl radical, an alkoxy radical, in each case having from about 1 to 4 carbon atoms, or a halogen, such as chlorine, bromine or fluorine; and s is zero or an integer 1, 2, 3 or 4; and if there is more than one radical T these are independent of one another and identical or different. The naphthoyl copolyesters may contain from about 10 to about 90 mol %, including from about 25 to 45 mol %, of structural units of the formula I, and from about 90 to 10 mol %, including from 85 to 55 mol %, of structural units of the formula II, where the proportions of structural units of the formulae I and II together give 100 mol %.

European Patent EP0278066 and U.S. Pat. No. 3,637,595 describe other liquid-crystalline polyesters suitable for the molding compositions of the invention, and mention oxybenzoylcopolyesters containing structural units of the formulae III, IV and V, where one or more of the structural units specified may be present in each case.

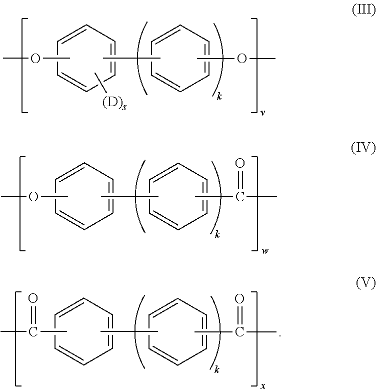

In the formulae III, IV and V, k is zero or 1; v, w, and x are integers equal to or greater than 1; the D selected is an alkyl radical having from about 1 to 4 carbon atoms, an aryl radical, an aryl alkyl radical having from about 6 to 10 carbon atoms in each case, or a halogen, such as fluorine, chlorine or bromine, and s is as defined above, and if there is more than one radical D, these are independent of one another and identical or different. The total of the indices v, w and x is from about 30 to 600. The oxybenzoylcopolyesters generally contain from about 0.6 to 60 mol %, including from about 8 to 48 mol %, of structural units of the formula II, from about 0.4 to 98.5 mol %, including from about 5 to 85 mol %, of structural units of the formula IV, and from about 1 to 60 mol %, including from about 8 to 48 mol %, of structural units of the formula V, where the proportions of the structural units of the formulae III, IV and V together give 100 mol %.

Other suitable copolyesters include those which contain only structural units of the formulae III and V. These liquid-crystalline polymers generally contain from about 40 to 60 mol % of the structural units of the formula III, and from about 60 to 40 mol % of structural units of the formula V. In some cases, the amounts of formulae III and V have a molar ratio of about 1:1. Polyesters of this type are described, by way of example, in U.S. Pat. Nos. 4,600,765; 4,614,790; and 4,614,791.

Other suitable copolyesters are those which, besides the structural units selected from the formulae III to V, also contain those of the formulae I and/or II; e.g., with from about 15 to 1 mol % of structural units of the formula I, from about 50 to 79 mol % of those of formula II, from about 20 to 10 mol % of those of formula III, and from about 20 to 10 mol % of those of formula V.

Other liquid-crystalline polymers which may be used in the present composites include copolyesteramides which, besides one or more structural units of the formulae Ito V, also have at least one structural unit of the formula VI or VII:

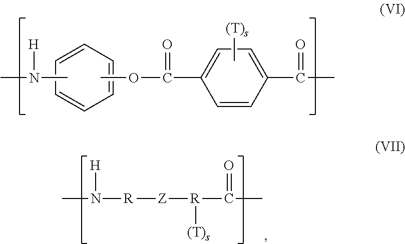

where R may be phenylene or naphthalene; Z may be a CO or O (oxygen) group; and T and s are as defined above. The liquid-crystalline polymers may be used individually or as mixtures.

Other suitable liquid-crystalline polymers also include, in addition to the structural units I to VII, at least one structural unit VIII

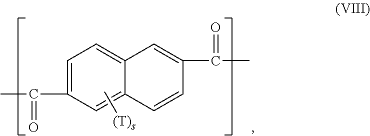

where T and s are as defined above.

In some embodiments, the polymer can be Vectra™ A950RX liquid crystal polymer (LCP) from Ticona North America (Florence, Ky.), a highly ordered thermoplastic copolymer consisting of about 73 mole percent hydroxybenzoic acid and about 27 mole percent hydroxynaphthoic acid. This liquid crystal polymer has properties amenable for use in fuel cell bipolar plates, including high dimensional stability up to temperatures of 250° C., extremely short molding times, exceptional dimensional reproducibility, chemical resistance to acidic environments present in a fuel cell, and has a low hydrogen permeation rate. In addition, Vectra™ can be molded into thin wall sections needed to reduce the volume and weight of a fuel cell assembly. Volumetric electrical conductivity of Vectra A950 RX is reported to be about 4.53×10⁻¹⁷ S/cm.

In some embodiments, the polymer may comprise a thermoplastic fiber. Suitable thermoplastic fibers can be fine with respect to linear mass density (about 0.5 to about 20 denier) and can have a length of about 1 to about 5 cm (and may have a surface treated with a dispersing aid). The thermoplastic fibers may be melted so that they adhere to each other and/or the fillers in the electrically conductive composite and can be subsequently solidified to form a mat or sheet material with the fillers impregnated in the thermoplastic matrix. The thermoplastic fibers may be used at about 10-50 wt %, including about 20-40 wt %. Choice of thermoplastic fibers can vary widely depending on the application, with suitable examples including polyesters, polyamides (e.g., nylon 6, 66, 11, 12, 612 and high temperature nylons, such as nylon 46), polypropylene, copolyetheresters, polyphenylene sulfide, polyethylene terephthalates, polybutylene terephthalate, polyetheretherketones, polyeetherketoneketones, and liquid crystalline polymer fibers, and mixtures thereof.

The electrically conductive composite, including the polymer (e.g., thermoplastic fibers) may further comprise reinforcing fibers that can have a size ranging from about 20 microns to about 1.5 inches. Examples of suitable reinforcing fibers include but are not limited to glass fibers, carbon fibers, metal fibers, polyaramid fibers (e.g., Kevlar™), and metal whiskers. In some cases, the reinforcing fiber(s) may have a dual role, where carbon fibers may act as reinforcing fibers and may also operate as an electrically conductive filler. The reinforcing fibers can provide structural rigidity to the composite material, for example, in the form of a mat or sheet. In some embodiments, the reinforcing fibers are present at about 5-15 wt %.

In some embodiments, the polymer or the polymer with one or more fillers may be prepared using emulsion polymerization. For example, emulsion polymerization of polystyrenes (PS) may be carried out using an oxygen-free atmosphere, where about 252 g styrene is mixed with about 712 g water in the presence of about 26 g sodium dodecyl sulfate (SDS) surfactant and about 0.7 g sodium carbonate (Na₂CO₃) buffer. The reaction may be initiated using about 0.7 g sodium persulfate (SPS) dissolved in about 5 g of water. The polymerization may be performed at a constant temperature of about 50° C. The resulting polystyrene polymer, according to this example, includes predominantly high molecular weight polymeric chains having a peak molecular weight of about 1,000,000 g/mol with about 20 wt % of the chains having a molecular weight lower than 20,000 g/mol.

In some embodiments, the present composites may include one or more additives. These additives may facilitate manufacturing or processing of the composite or components thereof and/or may provide improved properties to the final composite material. One such additive is a solvent which may be used to stably dissolve or disperse a polymer binder in the matrix. Examples of suitable solvents include alcohols such as methanol, ethanol, propanol, hexanol, and ethylene glycol; aromatic hydrocarbons such as xylene, and toluene; aliphatic hydrocarbons such as cyclohexane; ketones such as acetone and methyl ethyl ketone; esters such as ethyl acetate, and butyl acetate; ethers such as ethylene glycol monobutyl ether; and mixtures thereof, in addition to water. The electrically conductive composite, for example in the form of a curable coating or a paste, may include an aqueous solution of one or more polymer components and fillers dispersed in water. Other optional additives include polymerization initiators, crosslinking agents, photoinitiators, pigments, antioxidants, ultraviolet (UV) stabilizers, dispersants, antifoaming agents, thickening agents, plasticizers, tackifying resins, silane coupling agents, brightening agents, and the like.

Additional additives further include the following: various reinforcing materials, as illustrated, including for example fibers, in particular glass fibers, carbon fibers, aramid fibers, and mineral fibers; processing aids; polymeric lubricants; lubricants with external and/or internal lubricant action; surfactants; ultrahigh-molecular-weight polyethylene (UHMWPE); polytetrafluoroethylene (PTFE) or a graft copolymer which is a product made from an olefin polymer and from an acrylonitrile-styrene copolymer in a graft reaction; antioxidants; adhesion promoters; waxes; nucleating agents; mold-release agents; glass beads; mineral fillers, such as chalk, calcium carbonate, wollastonite, silicon dioxide, talc, mica, montmorillonite, organically modified or unmodified; organically modified or unmodified phyllosilicates; materials forming nanocomposites with the polymer (e.g., polyarylene sulfide); or nylon nanocomposites, or mixtures of such additives.

The lubricant used with predominantly external lubricant action may be solid and/or liquid paraffins, montanic esters, partially hydrolyzed montanic esters, stearic acids, polar and/or non-polar polyethylene waxes, poly-a-olefin oligomers, silicone oils, polyalkylene glycols or perfluoroalkyl ethers. The lubricant may be a high-molecular weight polyethylene wax which has been oxidized and is therefore polar. Oxidization of the polyethylene wax can improve its tribological properties and permits a less pronounced fall-off in mechanical properties. For example, the oxidized polyethylene wax can be a high-molecular-weight polar wax with an acid value of from about 12 to about 20 milligrams of potassium hydroxide per gram and a viscosity of from about 3,000 to about 5,000 millipascal-second at 140° C. Montanic (octacosanoic acid) esters and partially hydrolyzed montanic esters are examples of lubricants with external lubricant action.

Lubricants with predominantly internal lubricant action include: fatty alcohols, dicarboxylic esters, fatty esters, fatty acids, fatty acid soaps, fatty amides, wax esters, and stearyl stearates.

Surfactants include compounds capable of binding with the one or more fillers to promote dispersion of the filler throughout the polymer. The surfactant can have an alkyl chain length of about C1-C8, including C1-C4. The surfactant may react a filler to form a surface-functionalized filler. The surfactant may be bonded to the filler, for example, by coordination bonds, ionically bonded, bonded by van der Waals forces, or other forces. The “bond” between the surfactant and filler means that the surfactant and the filler are associated with each other by any force or attachment means including chemical, electrical, or mechanical interaction. In some cases, the surfactant may be thermally debonded from the filler at or above a debonding temperature. The debonding temperature may be determined by differential scanning calorimetry, for example. The surface functionalized filler may be more easily distributed homogeneously into the polymer matrix; however, the surfactant may increase the electrical resistance of the composite due to insulating properties of the surfactant or by raising the melting temperature or degree of adhesion of the filler. In such cases, the electrical conductivity of the composite may be negatively impacted by the presence of the surfactant. In certain embodiments, it may therefore be desirable for at least a portion of the surfactant to be thermally debonded from the conductive filler during curing of the polymer, for example. This may be achieved where the curing temperature of the polymer is above the surfactant debonding temperature.

In some embodiments, the electrically conductive composite comprises a polymer and one or more fillers, where the combined amount of fillers is from about 20 weight percent to about 80 weight percent of the composite, and the remaining balance of the composite may include the polymer. The ratio of filler(s) to polymer can depend on the composition, shape, and morphology of the filler(s). The concentration of filler should be sufficient to decrease the contact points and the electrical resistance of the polymer in the composite, but the concentration of filler cannot be too high such that viscosity of the material prohibits the chosen processing method. For example, excessive viscosity can prevent extrusion of polymer and filler particles to form the electrically conductive composite and can also prevent successful injection molding of articles formed of the composite.

In some embodiments, electrically conductive composite includes a first filler and a second filler, where the first filler comprises about 5% to about 95% of the total amount of filler in the composite, and hence the second filler may comprise from about 95% to about 5% of the total filler in the composite. The ratio of the first filler to the second filler may be adjusted based on geometry and/or electrical conductivity of each filler. For example, the ratio of the first filler to the second filler may range from about 80:20, 65:35, 45:55, 40:60, and 20:80.

An example of an electrically conductive composite comprises a polymer, a first filler comprising acicular metal particles, and a second filler comprising metal coated porous mineral particles. The polymer may comprise polyphenylene sulfide (PPS). The acicular metal particles of the first filler may be acicular copper particles and in some cases the acicular copper particles may be further coated with silver. The second filler may be metal coated perlite particles, such as copper and/or silver coated perlite particles. Mass percents of these components in an electrically conductive composite can include about 15% to about 25% polymer, about 25% to about 35% first filler, and about 45% to about 55% second filler, where the total equals 100% and the composite provides a conductivity of from about 1400 S/cm to about 1600 S/cm. In one example, the electrically conductive composite includes about 21.27% polymer comprising polyphenylene sulfide, about 27.63% first filler comprising silver-coated acicular copper particles, and about 51.10% second filler comprising silver and copper coated perlite particles, where the composite provides a conductivity of about 1500 S/cm.

A working example of an electrically conductive composite is prepared by injection molding the composite formulation shown in Table 1 and forming the composite into a plate. Characteristics of the resulting material are provided in the Table and the relationship between voltage and current is determined based on the relationship V=IR, where V is voltage, I is current, and R is resistance.

TABLE 1
Cryo-fractured with silver paste applied.

| Current | Voltage | | | |
|---|---|---|---|---|
| (mA) | (mV) | Processing terms | | |
| 1 | 0.0043 | Injection | Resistance (Ω) | 0.00410 |
| | | molded sample | | |
| 2 | 0.0084 | PPS (21.27%) | Area (cm²) | 0.28899 |
| 5 | 0.0207 | Acicular Cu | Length (cm) | 1.78 |
| | | (27.63%) | | |
| 10 | 0.0414 | Cu—Ag Perlite | Resistivity | 0.000666 |
| | | (51.1%) | (Ω · cm) | |
| 15 | 0.0610 | | Conductivity | 1502.288 |
| | | | (S/cm) | |
| 20 | 0.0826 | | | |
| 25 | 0.1032 | | | |
| 30 | 0.1238 | | | |
| 35 | 0.1445 | | | |
| 40 | 0.1652 | | | |
| 45 | 0.1860 | | | |
| 50 | 0.2066 | | | |

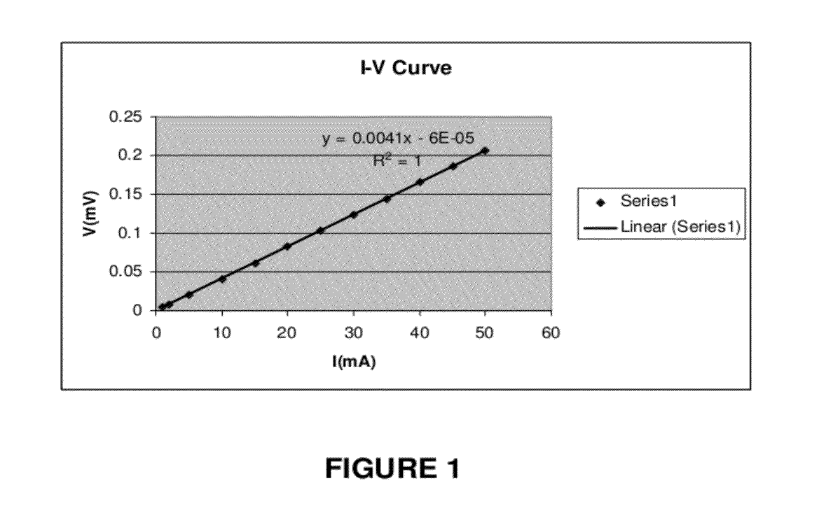

With reference to FIG. 1, the electric potential (in millivolts) is measured as a function of current (in milliamperes) applied to the electrically conductive composite illustrated in Table 1. The relationship between Voltage and Current demonstrates that the slope of the linear function corresponds to a resistance of 0.00410Ω. Resistivity is based on Ω·cm of the composite, determined by resistance multiplied by cross-sectional area divided by length. The resulting conductivity value of the composite is the inverse of the resistivity value.

Another example of an electrically conductive composite comprises a polymer, a first filler comprising acicular metal particles, and a second filler comprising metal coated porous mineral particles. The acicular metal particles can comprise needle and/or star-shaped copper particles and the metal coated mineral particles can comprise silver-coated, copper-coated, and/or both silver and copper coated perlite. The polymer may comprise a polyamide such as nylon. These components may be present in the composite at about 15% to about 25% polymer, about 25% to about 35% acicular metal particles, and about 45% to about 55% mineral particles, where the total equals 100% and the conductivity of the composite is from about 680 S/cm to about 780 S/cm. In one example, the electrically conductive composite includes about 18.2% nylon, about 28.57% acicular copper particles, and about 52.86% perlite particles, where the composite has a conductivity of about 734 S/cm.

Another example of an electrically conductive composite comprises a polymer comprising polycarbonate and a filler comprising metal coated porous mineral particles. The metal coated porous mineral may be perlite, where the perlite may be coated with silver, copper, or both silver and copper. The composite may include from about 45% to about 55% of the polymer and from about 45% to about 55% of the metal coated porous mineral particles, where the total equals 100%. Such composites can have conductivities ranging from about 20 S/cm to about 40 S/cm. In one example, the electrically conductive composite includes about 50% polycarbonate and about 50% silver and copper coated perlite particles and provides a conductivity of about 30 S/cm.

Several methods may be used to prepare and/or modify fillers for use in the present electrically conductive composites. Fillers may be prepared by coating a porous filler particle, such as a mineral particle, with a metal or metal particle. In an some embodiments, a method includes mixing a solution of an organic diol with a plurality of porous filler particles to obtain a support mixture; contacting a metal salt solution with the support mixture forming a reaction mixture; heating the reaction mixture to a temperature within a temperature range from about 20 degrees Celsius to about 200 degrees Celsius, where the metal cations in the metal salt solution are reduced to metal particles and are disposed on the surface of the porous filler particles, including the surface within the pores of the filler particles. In some embodiments, the method may further include isolating the metal coated filler particles.

An amount of porous filler particles, for example, a weighed amount of expanded perlite (commercially available as Norlite®, NorCal, Richmond Calif., USA; N50; density of about 4.5 to about 6.6 pounds per foot cubed, mesh size about 24 to about 100; and Fillite® commercially available from KELTECH Energies Ltd., India) can be dispersed in a volume of organic diol, for example, 100 milliliter (mL) of ethylene glycol heated to a temperature within a temperature range of about 150 degrees Celsius to about 200 degrees Celsius thereby forming a support mixture. The support mixture dispersion is then mixed with a measured amount (either in solid form or in solution form) of a metal salt solution, thereby forming a reaction mixture. The reaction mixture is then heated to a temperature within a temperature range from about 20 degrees Celsius to about 200 degrees Celsius, including from about 160 degrees Celsius to about 180 degrees Celsius in some cases. Optionally, to facilitate wetting of the porous filler particles, an ultrasonicator (e.g., Ultrasonic Systems, Bangalore, India) can be placed in contact with the reaction mixture and pulsed, for example, from about one to about five times at about 35 to about 50 kilohertz at about 120 Watts power setting.

The reaction mixture can be stirred in a vessel while maintaining the reaction mixture within a temperature range from about 20 degrees Celsius to about 200 degrees Celsius, including from about 160 degrees Celsius to about 180 degrees Celsius. The time required to heat the reaction mixture can vary, but the typical heating period generally ranges from about 1 minute to about 24 hours. In some embodiments, the heating period ranges from about 1 minute to about 5 hours and may range from about 1 minute to about 1 hour. The metal cations in the reaction mixture are reduced by the organic diol to metal particles having a zero valence state.

Once the majority of the metal cations have been reduced to metal on the porous filler particles and on the filler particle pore surfaces, the metal coated filler samples can be taken out after about 15 minutes to about 1 hour. The metal coated filler particles can be isolated from the liquid reactants by several known methods, including, washing and filtration, centrifugation, and sedimentation. The metal coated filler particles can be recovered from the reaction mixture, for example, using a Büchner funnel having an appropriate filter attached to a vacuum source. Laboratory methods for recovering particles using a Büchner funnel include those described in Shapiro J, “High-Rate Laboratory Filtration with Büchner Funnels,” Science (1961);133(3467):1828-1829.

In some embodiments, filters used to capture acicular high aspect ratio metallic particles having a first (x) dimension ranging from about 0.1 micrometers to about 10 micrometers and a second (x) dimension ranging from about 1 micrometers to about 100 micrometers include filters commercially available from Millipore, Billerica, Mass. and from Whatman Kent, United Kingdom. Solid metallic particles can be washed after separation from the precipitation mixture with water until the conductivity of the wash water is about 20 micro-ohms or less. Optionally, isolated metal coated filler particles can be washed with an organic solvent, such as a small chain alcohol. Water and/or solvent can then be removed from the filler particles and the filler particles dried.

Once washed, isolated metal coated filler particles can be dried in an oven set to a temperature falling within a range from about 40 degrees Celsius to about 150 degrees Celsius for a period of time ranging from about 1 hour to about 24 hours. The resulting metal coated filler particles may then be used in methods of forming an electrically conductive composite. For example, microscopy may be used to ascertain the extent that a porous mineral particle is coated with metallic particles. Typically, the perlite particle has a plurality of pores and the metal particles can be seen coating the surface of the perlite pores. For example, scanning electron microscopy may be used to ascertain qualitative and quantitative aspects of metal coating methods for porous mineral particles.

Concentration of the metal salt solution used in the present coating methods may affect the resulting metal particle size on the porous filler particles. In some embodiments, smaller metal particle sizes may be produced that are substantially uniformly distributed throughout the entire surface available to the metal salt solution, including the particle surface and within the particle pores on the surfaces of the particle pores (also referred to as particle pore surfaces). Illustratively, embodiments of the present methods for making a metal coated filler can employ a final concentration of metal salt solution in the reaction mixture which is in the range of about 0.01 Molarity to about 1 Molarity. The final concentrations of the organic diol in the reaction mixture range from about 1 Molarity to about 10 Molarity. In some embodiments, the mole ratio of organic diol to metallic salt solution can range from about 1 to about 0.001. In some embodiments, a generalized reaction can include dispersing about 4 grams of copper acetate in 100 milliliters of glycol (0.2 Molarity). The ratios of metallic salt solution to organic diol can be scaled up or down according to the amount of metal coated filler particles needed.

As the surface area of the filler particles increases, a higher concentration of metal can be dispersed over the surface. As used herein, “BET surface area” refers to the surface area of a filler particle as determined by using the Brunauer, Emmett, Teller equation for multi molecular adsorption. For further details, explanations, and examples of use of the BET equation and its applications see Introduction to Colloid and Surface Chemistry, 2^{nd} Edition, D. J. Shaw, published by Butterworth (Publishers) Inc, 1978). The porous filler particles can have a surface area calculated using the BET method that ranges from about 10 to about 2000 m²/g, more preferably, the porous filler particles can have a surface area ranging from about 200 to 1500 m²/g, and most preferably from about 300 to about 1500 m²/g.

For example, if silver is dispersed over a support with a BET surface area of about 50 meters squared per gram (m²/g), approximately 67 percent of the surface may be covered by a fully-dispersed monolayer of silver at about 5 percent silver loading. But if the support BET surface area is about 200 m²/g, at a 5 percent silver loading only about 17 percent of the surface is covered by a silver monolayer, and the approximately 67 percent surface coverage is not approached until the silver loading is at about 20 percent.

In various embodiments, the metal salt solution may have a sufficient concentration of the metal cation in the presence of the organic diol to yield a metal loading on the porous filler particles ranging from about 400 percent weight of the metal to about 100 percent weight of the porous filler particles to about 100 percent weight of the metal to about 100 percent weight of the porous filler particles. In other words, the total weight of the metal particles on the final metal coated filler in relation to the total weight of the porous filler particles may range from about 4 to 1 to about 1 to 1. The metal loadings of the metal particles on the porous filler particles can range from about 100 to about 400 weight percent, or from about 100 to about 300 weight percent, or from about 100 to about 200 weight percent, or from about 100 to about 150 weight percent, or from about 150 to about 400 weight percent, or from about 200 to about 400 weight percent, or from about 250 to about 400 weight percent, or from about 300 to about 400 weight percent, or from about 350 to about 400 weight percent metal to 100 weight percent of the filler particle.

In some embodiments, a second metal (e.g., silver, a corrosion inhibiting metal, etc.) can be coated on metal coated filler that is already coated with the same or a different metal. Methods for making multi-metal coated filler particles include the steps of mixing a solution of an organic diol with a plurality of metal coated filler particles coated with a first metal to obtain a support mixture; adding a metal salt solution having the same or a different metal cation to the first metal coated on the metal coated filler particles with the support mixture forming a reaction mixture; and heating the reaction mixture to a temperature within a temperature range from 50 degrees Celsius to 200 degrees Celsius, whereby the metal cations in the metal salt solution are reduced to metal particles and are disposed on the surface and the pore surfaces of the metal coated filler particles.

In some embodiments, the metal coated filler can be coated with a second metal in an aqueous medium, for example, after copper has been deposited on to porous filler particles, silver can be coated on the copper coated filler. This involves reduction of silver from silver nitrate using sodium potassium tartrate as a reducing agent, depositing the silver onto the surface of the copper coated porous filler particles. Silver is therefore overlaid onto copper coated porous filler particles; however, the silver may also be deposited onto portions of the surface area of the porous filler particles that were not previously covered with copper particles.

Various methods may be employed to make electrically conductive composites. Methods include making electrically conductive composites containing various concentrations of single and multiple filler combinations. In some embodiments, a method of forming an electrically conductive composite comprises mixing at least one conductive filler and a polymer to form a composite, where the filler is dispersed throughout the polymer matrix. In some aspects, a metal filler and/or a metal-coated porous mineral filler are incorporated into a polymer or polymer precusor (e.g., epoxy resin) which is then cured.

Fabrication of composites comprising fillers may be difficult; one problem is forming a homogeneous dispersion of the fillers in the polymer matrix. This is at least partly due to the large surface area of the filler particles relative to the average particle dimensions. When this ratio is large, the viscosity of the formulation is also larger. For this reason, it can be relatively challenging to formulate highly filled homogeneous composites comprising porous fillers. Thus, to enhance the dispersion and to increase filler loadings in the polymer matrix, organic surfactants and lubricants may be used to surface functionalize the filler particles. In some embodiments, diacids may be used to functionalize the surface of metal-coated fillers.

Surfactants and lubricants may be added to the filler to make the filler more compatible with the polymer used in the composite and/or to prevent agglomeration of the filler particles. Several compounds have been used to functionalize metal fillers or metal-coated porous fillers. These compounds include monocarboxylic acids, dicarboxylic acids, organic surfactants, and combinations thereof. Embodiments of the present methods include reacting conductive metal fillers or metal-coated porous fillers with a compound, wherein the compound forms functionalized filler particles comprising a surfactant.

In some embodiments, methods of making electrically conductive composites comprise curing a polymer and/or polymer precursor to form a composite that includes filler particles. In composites with more than one filler, for example metal particles and metal-coated porous mineral particles, the fillers may be fused or agglomerated. The metal filler particles can fill the gaps between the metal-coated porous mineral particles to form a more conductive network having fewer contact points and improved conductivity with less resistance; i.e., fewer but more intimate contact points can lead to lower contact resistance.

The following example illustrates one embodiment of making an electrically conductive composite in accordance with the present methods. A polymer comprising Vectra A950RX pellets is dried in an indirectly heated dehumidifying dryer oven at 150° C. and then stored in moisture barrier bags. The polymer and filler are extruded into 3 mm diameter strands using an American Leistritz Extruder, model ZSE 27 (Somerville, N.J., USA). This extruder has a 27 mm co-rotating intermeshing twin screw with 10 zones and a length/diameter ratio of 40. The screw design was chosen to minimize filler degradation, while still dispersing the fillers well within the polymer. Polymer pellets are introduced at Zone 1. Composites containing a single filler introduce the filler into the polymer melt at zone 5, and for composites containing at least two fillers, one filler is introduced into the polymer melt at Zone 5 and the other filler is added to the polymer melt at Zone 7. Due to the large amounts of fillers added, it may not be possible to add all the fillers at the same zone and obtain good mixing. Schenck AccuRate gravimetric feeders (Whitewater, Wis., USA) are used to accurately control the amount of each filler added to the extruder. After passing through the extruder, the strands of composite are pelletized to produce nominally 3 mm long pellets and stored in moisture barrier bags prior to injection molding.

A Niiagata injection molding machine, model NE85UA4 (Wood Dale, Ill., USA), is used to produce the composite articles. This machine has a 40 mm diameter single screw with a length/diameter ratio of 18 mm. The lengths of the feed, compression, and metering sections of the screw are 396, 180, and 144 mm, respectively. A four cavity mold is used to produce 3.2 mm thick ASTM Type I tensile bars (end gated) and 6.4 cm diameter disks (end gated). Prior to conducting the electrical conductivity tests, the samples are conditioned at 23 degrees Celsius and 50% relative humidity for about 88 hours.

Two electrical conductivity test methods may be used (in-plane and through-plane) to characterize the injection molded composite articles. Volumetric in-plane electrical conductivity can be used on samples with an electrical conductivity greater than about 10⁻⁴ S/cm. This technique, also known as the four-probe method, measures the conductivity by applying a constant current (typically about 5-10 mA) and measuring a voltage drop over the center 6 mm of the sample. The through-plane electrical conductivity method may be used for samples with an electrical conductivity less than about 10⁻⁴ S/cm. This method applies a constant voltage (typically about 100 V) and the resistivity is measured according to ASTM D257. Additional electrical conductivity test method details are known in the art.

In addition to extrusion, the present compositions may be made by methods employing processes known for processing thermoplastics, such as kneading, extrusion, injection molding, transfer molding, and compression molding.

The median particle dimensions of the filler, such as the aspect ratio, can be important for developing good electrical conductivity in the composite. In order to avoid excessive reduction of filler particle dimensions by high shear forces, non-aggressive preparation and shaping processes may be employed. For example, acicular copper particles or silver coated acicular copper particles may be deformed and metal-coated porous mineral particles may fragment, crack, or be crushed by high-sheer mixing. Thus, lower viscosity, slower mixing, and reduced filler amounts may be used to mitigate any degradation of filler particle dimensions during the chosen mixing process.

In relation to the properties of the final composite, it may be advantageous to use processes in which preparation and shaping are combined in a single-stage process. Examples of include injection molding-compounding with or without an injection-compression molding unit and the melt-application compression-molding process, which is based on the combination of a preparation assembly (single-screw, twin-screw or the like) and a compression-molding unit. Such suitable single-stage processes are known in the art. For example, with respect to injection molding-compounding without injection-compression molding unit, see R. Jensen: Synergien intelligent nutzen—IMC-Spritzgiesscompounder erhoht Wertschopfung [Intelligent utilization of synergies—IMC Injection-molding compounder increases value-added]; Kunststoffe plast europe, 9/2001; and also R. Jensen: Synergie schafft neue Technologie [Synergy creates new technology]; Kunststoffe plast europe 10/2001, incorporated herein by reference. With respect to injection-molding compounding with injection-compression molding unit (known as injection-compression molding), see F. Johannaber, W. Michaeli: Handbuch Spritzgiessen [Injection molding handbook], Carl Hanser-Verlag, Munich (2001), ISBN 3-446-15632-1, p. 417; and also H. Saechtling: Kunststofftaschenbuch [Plastics handbook], 27th edition, Carl Hanser-Verlag, Munich (1998), ISBN 3446-19054-6, p. 226, incorporated herein by reference. With respect to melt-application compression molding, see T. Hofer: Fillflow—A comparison between simulation and experiment in the case of the extrusion compression moulding. Proceedings of the 3rd ESAFORM Conference on Material Forming, Stuttgart (2000); ISBN 3-00-005861-3; and also R. D. Krause, Dissertation, Stuttgart University, Process Technology Faculty, Institut Kunststofftechnologie [Institute for Plastics Technology] (1998); Modellierung and Simulation rheologisch-thermodynamischer Vorgänge bei der Herstellung grossflächiger thermoplastischer Formteile mittels Kompressionsformverfahren [Modeling and simulation of rheological-thermodynamic processes during the production of large-surface area thermoplastic moldings by compression-molding processes], incorporated herein by reference.

In particular, an injection-molding compounder (IMC) may be used in the present methods. An IMC can be advantageous because preparation and shaping of the filled system take place in one step, without reheating. If, in addition, an injection-compression molding unit or compression molding unit is utilized, any damage to filler particles can be dramatically reduced when comparison is made with simple injection molding. Damage to particles, brought about by high shear stresses and deformation at high injection rates, may reduce conductivity significantly by factors of from about 3-fold up to about 10-fold. Use of the injection-compression molding unit permits non-aggressive injection of a shot of melt within the cavity and permits final shaping of the component to be brought about by fully closing the cavity.

Another process which can be advantageous is shaping via compression (i.e., compression molding), using a compression mold (positive mold). This process is well-known in the art and is suitable for use in the present methods. See, for example, Kunststofftaschenbuch [Plastics handbook], 25th edition, Carl Hanser-Verlag, Munich (1998), ISBN 3-446-16498-7, pp. 113 et seq., incorporated herein by reference. In some embodiments, it may be advantageous for the extruded composite to be pre-ground, e.g. on a grinder, or jaw crusher, or in a ball mill or pinned disc mill, where the ground, particulate composite is used as a feedstock for the compression molding process to form a composite article. In such cases, the ground, particulate composite (to be compression molded) may have particle size of from about 50 micrometers to 1500 micrometers, about 100 micrometers to about 1000 micrometers, or about 150 micrometers to about 800 micrometers.

The electrically conductive composite may be used in any application where there is a need for high conductivity plastics; e.g., from about 1 to about 1500 S/cm. By providing the necessary electrical conductivity at acceptable filler loadings, the present composites may be used in commercial applications relating to: conductive paints and inks; conductive coatings; conductive sealants, caulks, and adhesives; electromagnetic shielding for large structural components; electrostatic painting; electrostatic discharge; and opto-electronic device applications. The present composites are also attractive for use in electromagnetic interference (EMI) shielding and electrostatic discharge (ESD) coatings, and as thin-film field-emitters and (at low filler contents) transparent conductors.

Applications of the present composites further include parts of fuel cells, in particular parts of end plates of a fuel cell, or for end plates or bipolar plates of fuel cells. The bipolar plates, end plates, or parts of end plates produced from molding the present composites are suitable for producing high-output fuel cells with a specific output greater than one kilowatt per kilogram, can achieve specific electrical conductivities greater than 100 S/cm, and are chemically resistant to most, if not all, materials used in operating a fuel cell, including water, acids, hydrogen, and methanol. In addition, the composite and articles formed from the composite can be impermeable to liquids and gases used within the fuel cell.

In some embodiments, the heat distortion temperature of the electrically conductive composite is above 130° C. at 1.82 MPa test load. Flexural strength can be from about 30 to about 50 MPa. Since it is possible to use conventional injection molding or injection-compression molding, and therefore no machining may be required needed, high production rates can be achieved. By selecting a suitable filler or combination of fillers, it is possible to produce composites which have substantially similar electrical properties but with from about a 10% to about 23% reduction in the amount of filler in relation to polymer, thereby providing from about a 3% to about a 10% reduction in component density in some cases. Likewise, mechanical and rheological properties can be improved by reducing the amount of filler. Composite articles manufactured according to the present methods are therefore suitable for application in mobile fuel cells, where reduced weight is important, as well as for use in stationary fuel cells.

In some embodiments, a polymer can be added to a metal coated filler. The conductive composite (e.g., paste, etc.) can also be made by mixing a polymer matrix material with the metal coated filler along with one or more additional fillers, including lobe-shaped particles, acicular-high aspect ratio metal particles, round metal particles, and flaky metal particles. These additional fillers can optionally be coated on other siliceous and/or non-siliceous particles as described herein, for example, perlite particles. The electrically and/or thermally conductive material (e.g., paste, etc.) can then be applied (e.g., coated onto, etc.) to at least one surface of the substrate.

In some embodiments, the metal coated filler can be admixed with a polymer that can include a binder and optionally a solvent to form a conductive paste (or other material) that can be applied or coated to a variety of substrates. Coatings employing the metal coated filler produced by the present methods can be applied to conductive and non-conductive substrates useful in the manufacture of multilayer ceramic capacitors, conductive films, and conductive tapes. The metal coated filler, polymer, and optionally a solvent can be formulated and applied to a variety of transparent and non-transparent films and other surfaces for various optical-electronic devices, such as optical filters for light scattering, radio frequency identification tags and labels, and microelectromechanical systems.

In some embodiments, coatings employing a metal coated filler are used together with an inherently non-conductive substrate such as glass, ceramic, and plastic. When the metal coated filler is admixed with a polymer comprising a binder and optionally a solvent, the resultant conductive material (e.g., paste, etc.) can be coated on a conductive or non-conductive substrate by various coating manners, such as brush coating, spray coating, roll coating, spin coating, printing, sputtering, chemical vapor deposition, and dip coating. Optionally, once the conductive material (e.g., paste, etc.) has been applied to at least a surface of the substrate, the conductive material can be cured or polymerized and then the article can be dried in an oven set to at least 100 degrees Celsius for a period ranging from about 30 minutes to about 4 hours.

In some embodiments, conductive pastes including the present composites can be used to make electrically conductive tapes. Conductive pastes can be coated onto conductive and non-conductive fibers to create a cloth like material that is electrically conductive. Exemplary conductive fibers include micron conductive fibers, for example, nickel plated carbon fiber, stainless steel fiber, copper fiber, silver fiber, aluminum fiber, or the like, or combinations thereof. Non-conductive fibers can also include Teflon®, Kevlar®, poly(ethylene terephthalate) and other abrasion resistant fiber materials that can be woven into a tape or cloth. Webbed, conductive fiber can be laminated or the like to materials such as Nylon®, Teflon®, polyesters, or any resin-based flexible or solid material(s), which when discretely designed in fiber content(s), orientation(s) and shape(s), will produce a highly conductive flexible cloth-like material. Such a cloth-like material could also be used in forming electrically conductive tapes and films that can be embedded in a person's clothing as well as other resin materials such as rubber(s) or plastic(s). When using conductive fibers as a webbed conductor as part of a laminate or cloth-like material, the fibers can have diameters of from about 3 microns to about 12 microns, typically from about 8 microns to about 12 microns, or about 10 microns, with length(s) that can be seamless or overlapping.

In various embodiments, a conductive paste can be applied directly onto a cloth material or substrate made from natural or synthetic fibers described above. The matrix material in the conductive paste can be formulated to include polymers and/or copolymers that are made to provide adhesion to other flexible or solid substrates. Such electrically conductive tapes and films can find applications in electronic devices, for example, cellular phones, personal digital assistants, computers, circuit boards, logic boards, televisions, radios, domestic appliances on the interior and/or exterior of military weapons and equipment, medical devices, for example, to provide electromagnetic interference (EMI) shielding and grounding. Conductive tapes can be made having a coating of a conductive paste of an embodiment of the present technology described above; the conductive paste can be applied in an amount of 0.01 grams per square centimeter (g/cm²) to about 5 g/cm² to the tape substrate to provide electromagnetic shielding and grounding and provide thermal protection for the above electrical devices and components.

The present electrically conductive composites may be used in a variety of electroconductive applications (e.g., highly electrically conductive injection moldable thermoplastic composites used for interconnects, circuit boards, manufacture of semiconductor devices, radio frequency identification, printed and flexible circuits, etc.) and/or thermally conductive applications (e.g., highly thermally conductive injection moldable thermoplastic composite applications, etc.). The following non-limiting examples are provided to further illustrate various embodiments and applications.

As a first example, an injection moldable electrically conductive composite that includes a metal coated filler and a polymer may be used to provide board level shielding, such as used with electronics and home appliances. Some existing EMI solutions involve multiple steps to achieve desirable electrical conductivity and EMI shielding and/or include relatively complex parts that are difficult to manufacture. In this example, an injection moldable electrically conductive polymer composite that includes a metal coated filler may be configured to satisfy the following specifications, for example, to offer lighter weight, injection moldability, and form in-place gasket applications: electrical conductivity greater than 10 Siemens per centimeter (S/cm), shielding effectiveness much greater than 60 decibels, thermal stability of about 120 degrees Celsius, modulus greater than 7 Gigapascals, and a UL Flammability rating of V0 or V1.

Another example application relates to modular connectors and covers, such as for use with electronics. High electrical conductivity is generally needed to get good EMI shielding. In this example, an injection moldable electrically conductive polymer composite that includes a metal coated filler may be configured to satisfy the following specifications, for example, to offer lighter weight and injection moldability: electrical conductivity greater than 10 Siemens per centimeter, shielding effectiveness much greater than 60 decibels, thermal stability at about 60 to about 120 degrees Celsius, coefficient of thermal expansion less than 5×10⁻⁶/K at 23 degrees Celsius (3009<), and a UL Flammability rating of V0 or V1.

Another application relates to vent panels, such as for use with power electronics and consumable electronics. High electrical conductivity is generally needed to get good EMI shielding. Traditional vent panels may include metal meshes (of fixed sizes) and frame. Plus, multiple steps may be needed to get the desired EMI shielding. In this example, an injection moldable electrically conductive polymer composite that includes a metal coated filler may be configured to satisfy the following specifications, for example, to offer the ability to make single molded light weight parts, improved injection moldability, and allow for different mesh sizes and designs: electrical conductivity greater than 10 Siemens per centimeter, shielding effectiveness greater than 60 decibels, modulus greater than 7 Gigapascals, and a UL Flammability rating of V0 or V1.

An additional electrically conductive application relates to EMI enclosures (e.g., telemetric device covers, multimeter cover, gas sniff covers, optical encoder covers, speaker covers, laptop housings, etc.), such as for use with electronics and home appliances. Traditional processes typically involve multiple steps to achieve desirable electrical conductivity and EMI shielding. In this example, an injection moldable electrically conductive polymer composite that includes a metal coated filler may be configured to satisfy the following specifications, for example, to offer lighter weight, improved injection moldability of complex parts, and metal like conductivity: electrical conductivity much greater than 10 Siemens per centimeter, shielding effectiveness greater than 50 decibels, thermal stability at about 120 degrees Celsius, modulus greater than 7 Gigapascals, Class A surface, and a UL Flammability rating of V0 or V1.

Another example application relates to fuel cell bipolar plates, such as for use with power and energy applications and automotive applications. Traditional processes may use compression molded graphite, which may provide poor electrical conductivity that is often directionally dependent and/or has poor mechanical properties. In this example, an injection moldable electrically conductive polymer composite that includes a metal coated filler may be configured to satisfy the following specifications, for example, to offer very high electrical conductivity, need based custom design, and injection moldability: electrical conductivity greater than 100 Siemens per centimeter, thermal stability at about 120 degrees Celsius, modulus greater than 7 Gigapascals, chemical resistance, and a UL Flammability rating of V0 or V1.

An further example application relates to electrically conductive polymer composite substrates for organic light emitting diodes (OLEDs) and dye-sensitized solar cells (DSSC) (e.g., organic photovoltaic cells, etc.), such as for use with electronic displays, lighting, renewable energy, etc. Typically, multiple steps may be needed to get an electrically conductive polymer substrate. In this example, an injection moldable electrically conductive polymer composite that includes a metal coated filler may be configured to satisfy the following specifications, for example, to offer lighter weight and injection moldability: electrical conductivity greater than 100 Siemens per centimeter, a UL Flammability rating of V0 or V1, flexibility, ultraviolet stability, and oxygen permeability.

The present electrically conductive composites comprising a polymer and at least one conductive filler may be used in the methods and applications illustrated in the following references: “Conductive Polymer Composites”, HongJin Jiang, Kyoung-Sik Moon, Yi Li Ching Ping Wong, U.S. Patent Application Publication Number 2008/0272344; Zyvex Application Note 9709, Zyvex Corporation, USA; Conductive Plastic Molding Material, the Use Thereof and Moulded Bodies Produced Therefrom”, Hoffman, Achim; Fritz, Hans-Gerhard; Kaiser, Ralf; U.S. Pat. No. 7,419,720 dated Sep. 21, 2008; “Highly Conductive Thermoplastic Composites for Rapid Production of Fuel Cell Bipolar Plates”; Huang, JianHua; Baird, Donald G; and McGrath, James E; U.S. Pat. No. 7,365,121 dated Apr. 29, 2008; “High-Conductivity Polymer Nanocomposites Obtained by Tailoring the Characteristics of Carbon Nanotube Fillers”, Nadia Grassiord; Joachim Loos; Lucas van Laake; Maryse Maugey; Cecile Zakri; Cor E Koning and A John Hart; Advanced Functional Materials 18, 3226-3234, 2008; and “Electrical Conductivity Modeling of Multiple Carbon Fillers in Liquid Crystal Polymer Composites for Fuel Cell Bipolar Applications”, R. L. Barton, J. M. Keith and J. A. King; J. New Materials for Electrochemical Systems, 11, 181-186 (2008). The present composites may also include additional components as described in these references or may be used in conjunction with various aspects of these references.

In contrast to other compositions including multiple fillers, the present electrically conductive composites provide improved conductivity values. In particular, embodiments of the present compositions may provide conductivity values from about 1 S/cm to greater than about 1500 S/cm.

The embodiments and the examples described herein are exemplary and not intended to be limiting in describing the full scope of apparatus, systems, and methods of the present technology. Equivalent changes, modifications and variations of some embodiments, materials, compositions and methods can be made within the scope of the present technology, with substantially similar results.

1. An electrically conductive composite comprising:
a polymer; and
a filler comprising porous particles at least partially coated with metal.

2. The electrically conductive composite as in claim 1, wherein:
the porous particles at least partially coated with metal comprise porous particles at least partially coated with copper, silver, or copper and silver; and/or
the porous particles at least partially coated with metal comprise one or more of perlite, vermiculite, pumice, montmorillonite, wollastonite, zeolite, and combinations thereof.

3. The electrically conductive composite as in claim 1, wherein the filler further comprises metal particles.

4. The electrically conductive composite as in claim 4, wherein:
the metal particles comprise metal particles having an aspect ratio of at least 2:1 with respect to longest versus shortest axis; or
the metal particles comprise metal particles having an aspect ratio of at least 10:1 with respect to the longest versus shortest axis.

5. The electrically conductive composite claim 4, wherein:
the metal particles comprise acicular copper particles; and/or
the metal particles further comprise a coating of a different metal; and/or
the metal particles further comprise a coating of a different metal, and the coating of a different metal comprises silver.

6. The electrically conductive composite of claim 1, wherein the filler is substantially dispersed throughout the polymer.

7. The electrically conductive composite of claim 1, wherein the polymer comprises a thermoplastic polymer or a thermoset polymer.

8. The electrically conductive composite of claim 1, wherein the polymer comprises one or more of polyarylene sulfide, polyamide, polycarbonate, melamine, epoxy, polyimide, polystyrene, acrylic, polyester, alkyd, urethane, silicone, polyvinyl chloride, polyvinyl alcohol, liquid-crystalline plastic, nylon, polyphenylene sulfide, polycarbonate, polyesters, polyamides, polypropylene, copolyetheresters, polyphenylene sulfide, polyethylene terephthalates, polybutylene terephthalate, polyetheretherketones, liquid crystalline polymer fibers, and combinations thereof.

9. The electrically conductive composite of claim 1, wherein:
the electrically conductive composite has a conductivity within a range from about 1 S/cm to about 1500 S/cm; or
the electrically conductive composite has a conductivity within a range from about 700 S/cm to about 1500 S/cm.

10. An article comprising the electrically conductive composite of claim 1, wherein the article is a tape, film, adhesive, gasket, sealant, ink, paste, interconnect, circuit board, semiconductor, radio frequency identification tag, printed circuit, or flexible circuit.

11. A method of providing electromagnetic shielding for an electronic device, the method comprising using an electrically conductive composite of claim 1.

12. The method of claim 11, wherein:
the electronic device comprises an interconnect, circuit board, semiconductor, radio frequency identification tag, printed circuit, or flexible circuit; and/or
the electrically conductive composite provides electromagnetic interference shielding greater than about 50 decibels or greater than about 60 decibels.

13. A method of making an electrically conductive composite comprising mixing a polymer and a filler to substantially disperse the filler in the polymer, wherein the filler comprises porous particles at least partially coated with metal.

14. The method of claim 13, further comprising:
extruding the polymer and the filler to form an article comprising the electrically conductive composite; or
injection molding the polymer and filler to form an article comprising the electrically conductive composite; or
compression molding the polymer and filler to form an article comprising the electrically conductive composite.

15. The method of claim 13, wherein the method includes forming an article that is a tape, film, adhesive, gasket, sealant, ink, or paste.

16. The method of claim 13, wherein:
the porous particles at least partially coated with metal comprise porous particles at least partially coated with copper, silver, or copper and silver; and/or
the porous particles at least partially coated with metal comprise one or more of perlite, vermiculite, pumice, montmorillonite, wollastonite, zeolite, and combinations thereof.

17. The method of claim 13, wherein the filler further comprises metal particles.

18. The method of claim 17, wherein:
the metal particles comprise acicular copper particles; and/or
the metal particles further comprise a coating of a different metal; and/or
the metal particles further comprise a coating of a different metal, and the coating of a different metal comprises silver.

19. The method of claim 13, wherein the polymer comprises one or more of polyarylene sulfide, polyamide, polycarbonate, melamine, epoxy, polyimide, polystyrene, acrylic, polyester, alkyd, urethane, silicone, polyvinyl chloride, polyvinyl alcohol, liquid-crystalline plastic, nylon, polyphenylene sulfide, polycarbonate, polyesters, polyamides, polypropylene, copolyetheresters, polyphenylene sulfide, polyethylene terephthalates, polybutylene terephthalate, polyetheretherketones, liquid crystalline polymer fibers, and combinations thereof.

20. The method of claim 13, in which the resulting electrically conductive composite has a conductivity within a range from about 1 S/cm to about 1500 S/cm or within a range from about 700 S/cm to about 1500 S/cm.
